(19) United States
(12) Patent Application Publication
(10) Pub. No.: US 2024/0331459 A1
(43) Pub. Date: Oct. 3, 2024

(54) SENSOR ENABLED VEHICLE REPAIR VALIDATION

(71) Applicant: International Business Machines Corporation, Armonk, NY (US)

(72) Inventors: Seema Nagar, Bangalore (IN); Cristina Bonanni, Rome (IT); Tathagato Bose, Kolkata (IN); Luigi Pichetti, Rome (IT)

(21) Appl. No.: 18/191,257

(22) Filed: Mar. 28, 2023

(51) Int. Cl. G07C 5/08

(52) U.S. Cl. CPC G07C 5/0808

(57) ABSTRACT

A method of sensor enabled vehicle repair validation is provided including obtaining pre-repair sensor data from at least some pre-repair components of a vehicle. Post-repair sensor data is obtained from at least some post-repair components of the vehicle. The vehicle repair validation is performed by comparing the obtained post-repair sensor data to the obtained pre-repair sensor data using a difference model.

### BACKGROUND

Exemplary embodiments of the present inventive concept relate to vehicle repair validation, and more particularly, to sensor enabled vehicle repair validation.

Mechanic performed maintenance of a vehicle (e.g., car, boat, plane, etc.) can involve considerable expense to owners, particularly when faulty components require replacement/repair. However, vehicle owners are often layman; they lack the expertise to evaluate the legitimacy and completeness of mechanic performed car repairs. A widespread concern amongst vehicle owners is thus that mechanics may fail to perform the entirety of repairs represented despite substantial costs.

### SUMMARY

Exemplary embodiments of the present inventive concept relate to a method, a computer program product, and a system of sensor enabled vehicle repair validation.

According to an exemplary embodiment of the present inventive concept, a method of sensor enabled vehicle repair validation is provided. The method includes obtaining pre-repair sensor data from at least some pre-repair components of a vehicle. Post-repair sensor data is obtained from at least some post-repair components of the vehicle. The vehicle repair validation is performed by comparing the obtained post-repair sensor data to the obtained pre-repair sensor data using a difference model.

According to an exemplary embodiment of the present invention, a computer program product is provided capable of performing a method. The method includes obtaining pre-repair sensor data from at least some pre-repair components of a vehicle. Post-repair sensor data is obtained from at least some post-repair components of the vehicle. The vehicle repair validation is performed by comparing the obtained post-repair sensor data to the obtained pre-repair sensor data using a difference model.

According to an exemplary embodiment of the present invention, a computer system is provided capable of performing a method. The method includes obtaining pre-repair sensor data from at least some pre-repair components of a vehicle. Post-repair sensor data is obtained from at least some post-repair components of the vehicle. The vehicle repair validation is performed by comparing the obtained post-repair sensor data to the obtained pre-repair sensor data using a difference model.

### BRIEF DESCRIPTION OF THE DRAWINGS

The following detailed description, given by way of example and not intended to limit the exemplary embodiments solely thereto, will best be appreciated in conjunction with the accompanying drawings, in which:

FIG. 1 illustrates a schematic diagram of computing environment 100 including a sensor enabled vehicle repair validation program 150, in accordance with an exemplary embodiment of the present inventive concept.

FIG. 2 illustrates a block diagram of components included in the sensor enabled vehicle repair validation program 150, in accordance with an exemplary embodiment of the present invention.

FIG. 3 illustrates a flowchart of a method of sensor enabled vehicle repair validation 300, in accordance with an exemplary embodiment of the present inventive concept.

It is to be understood that the included drawings are not necessarily drawn to scale/proportion. The included drawings are merely schematic examples to assist in understanding of the present inventive concept and are not intended to portray fixed parameters. In the drawings, like numbering may represent like elements.

### DETAILED DESCRIPTION

Exemplary embodiments of the present inventive concept are disclosed hereafter. However, it shall be understood that the scope of the present inventive concept is dictated by the claims. The disclosed exemplary embodiments are merely illustrative of the claimed system, method, and computer program product. The present inventive concept may be embodied in many different forms and should not be construed as limited to only the exemplary embodiments set forth herein. Rather, these included exemplary embodiments are provided for completeness of disclosure and to facilitate an understanding to those skilled in the art. In the detailed description, discussion of well-known features and techniques may be omitted to avoid unnecessarily obscuring the presented exemplary embodiments.

References in the specification to “one embodiment,” “an embodiment,” “an exemplary embodiment,” etc., indicate that the embodiment described may include a particular feature, structure, or characteristic, but not every embodiment may necessarily include that feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether explicitly described.

In the interest of not obscuring the presentation of the exemplary embodiments of the present inventive concept, in the following detailed description, some processing steps or operations that are known in the art may have been combined for presentation and for illustration purposes, and in some instances, may have not been described in detail. Additionally, some processing steps or operations that are known in the art may not be described at all. The following detailed description is focused on the distinctive features or elements of the present inventive concept according to various exemplary embodiments.

Provided is a method, computer program product, and system for sensor enabled vehicle repair validation. The present inventive concept empowers vehicle owners to verify the comprehensiveness of mechanic represented vehicle repairs, real-time performance, involved costs, and identities of replaced components.

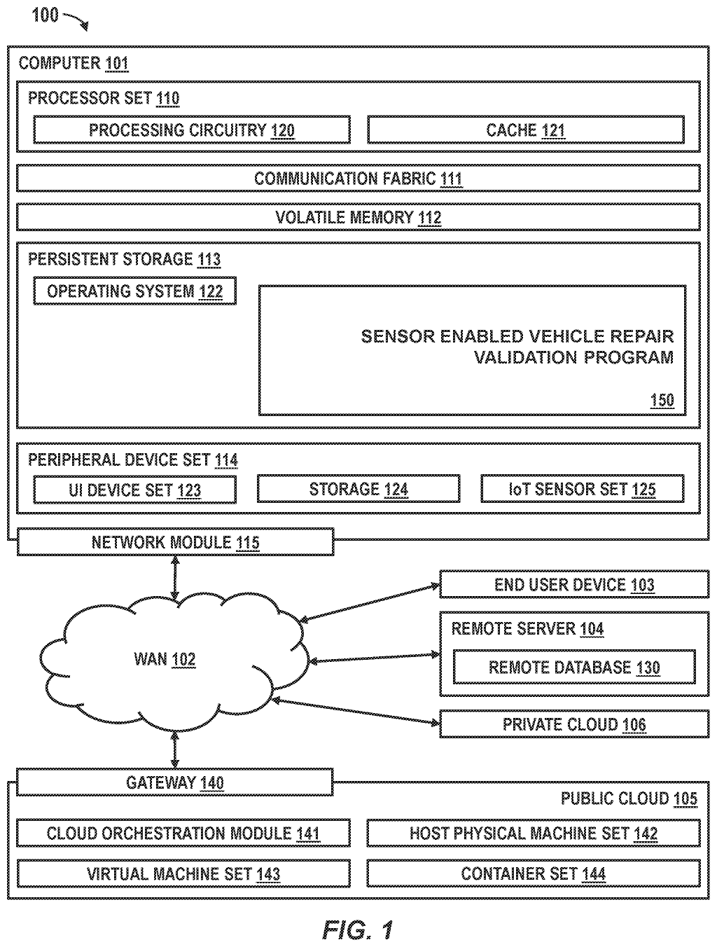

FIG. 1 illustrates a schematic diagram of computing environment 100 including a sensor enabled vehicle repair validation program 150, in accordance with an exemplary embodiment of the present inventive concept.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as a sensor enabled vehicle repair validation program 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

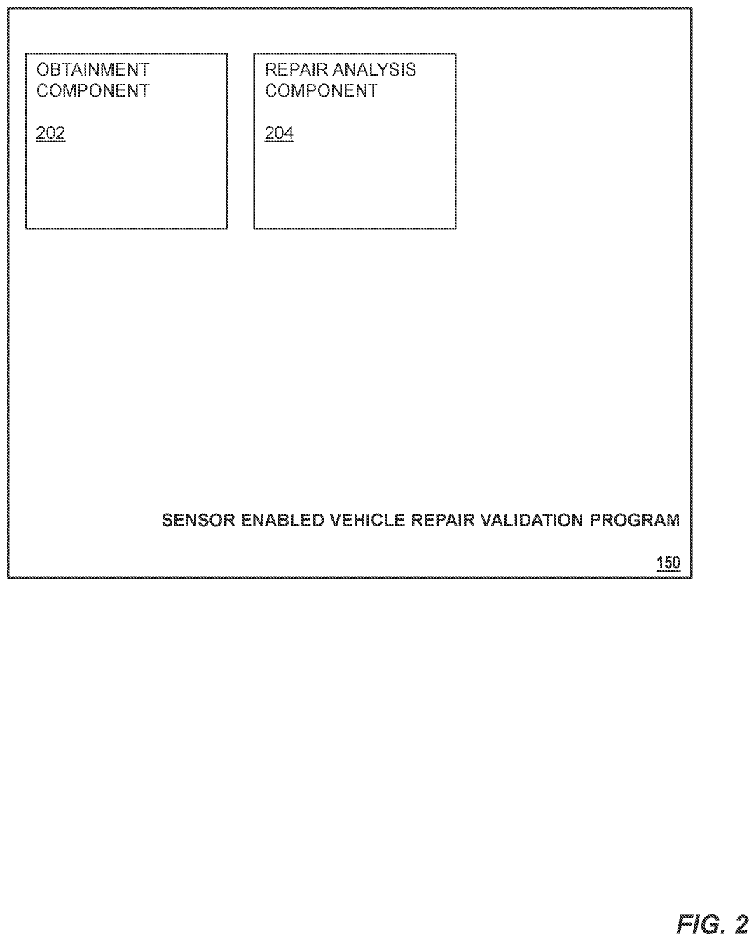

FIG. 2 illustrates a block diagram of components included in a sensor enabled vehicle repair validation program 150, in accordance with an exemplary embodiment of the present invention.

Obtainment component 202 can obtain sensor data from component sensors (e.g., IoT sensors) and/or sub-components thereof included in an assemblage (e.g., a vehicle). In an embodiment, each component and/or sub-component can have a sensor. The IoT sensors can include, but are not limited to, gas and chemical sensors, proximity sensors, pressure sensors, infrared sensors, motion sensors, optical sensors, gyroscope sensors, accelerometer sensors, humidity sensors, image sensors, smoke sensors, level sensors, RFID sensors, etc. The obtained sensor data can include pre-repair component data from at least some pre-repair components and post-repair component data from at least some post-repair components. A pre-repair component and a corresponding post-repair component can differ in at least one of RFID sensor, real-time performance (e.g., resource usage, component movement, etc.), make, model, and/or type, such as when repairs (e.g., replacement, substitution, restoration etc.) have been performed. The obtainment component 202 can obtain characteristic data for the overall assemblage, potential spare parts, constituent pre-repair components, and/or constituent post-repair components by user input or automatically via the network, such as upon a triggering event (e.g., forthcoming repair is indicated, new component is detected, etc.). The obtained characteristic data sources can include manufacturer content (e.g., animations, manuals, schematics, descriptions, etc.) related to an overall assemblage and/or constituent components. The obtainment component 202 can also receive represented repairs (e.g., itemized invoices, written/verbal representations, etc.) via user input and/or provided multimedia. The obtainment component 202 can upload the obtained sensor data to a user device (e.g., phone, desktop, laptop, cloud, terminal, etc.) that includes the sensor enabled vehicle repair validation program 150 and/or a software client thereof. Additionally, the user can input problems, such as persistent post-repair problems and/or new problems observed. The obtainment component 202 can obtain further data via the network related to keywords associated with the user input problems.

For example, a user uploads an itemized invoice from a mechanic to the sensor enabled vehicle repair validation program 150 related to repairs sought for a noisy car. The obtainment component 202 obtains pre-repair sensor data and uses identifying pre-repair component RFID signatures to obtain further characteristic data from the manufacturer. Upon detection of a new post-repair RFID, the obtainment component obtains post-repair sensor data and uses identifying post-repair component RFID signatures to obtain further characteristic data from the manufacturer. The user inputs persistent post-repair noise and the obtainment component performs an associated search.

The repair analysis component 204 can analyze the obtained sensor data, the characteristic data, the represented repairs performed, and/or the user input problems using AI processes (e.g., natural language processing (NLP), computer vision, etc.). Features extracted from the characteristic data, pre-repair component sensor data, post-repair component sensor data, and the represented repairs can include ignition, speed, instantaneous electrical power, friction (heating), assemblage dimensions and component arrangements, assemblage performance metrics, constituent component dimensions and arrangements, real-time constituent component performance metrics and motions, assemblage and component identities (e.g., MSRP, serial numbers, makes, manufacturers, models, types, recalls, RFID signature, year of manufacture, prior owners, etc.), etc. Features extracted from the user input problems can include complaints, such as rattling, sputtering, lurching, etc. The repair analysis component 204 can generate a pre-repair digital twin and post-repair digital twin based on the pre-repair component sensor data and the post-repair sensor data (e.g., RFIDs), respectively. In addition, the repair analysis component 204 can generate or obtain an ideal digital twin based on the manufacturer sourced data. The repair analysis component 204 can compare the pre-repair digital twin and the post-repair digital twin using a difference model (e.g., threshold KL divergence). In addition, the repair analysis component 204 can compare the ideal digital twin to at least one of the pre-repair digital twin and the post-repair digital twin. The repair analysis component 204 can detect differences (e.g., verify whether repairs were performed, what repairs were performed, what post-repair components are implicated, and characteristic features thereof) between the post-repair digital twin and the pre-repair digital twin. In an embodiment, the repair analysis component 204 can additionally compare the post-repair digital twin to the ideal digital twin (e.g., component interconnectivity, orientations, motions, real-time performance, etc.) and/or the analysis of represented repairs (e.g., component cost versus MSRP, inferior replacement component, restoration versus replacement, etc., deviations from expected performance, identity (e.g., name, RFID), prior ownership, country of manufacture, etc.), and notify the user of any discrepancy accordingly.

For example, the repair analysis component 204 generates an ideal digital twin, a pre-repair digital twin, and a post-repair digital twin. The repair analysis component analyzes the user uploaded itemized invoice from the mechanic and obtained data associated therewith. The extracted features from the itemized invoice include a muffler repair, a replacement muffler RFID, and a replacement muffler MSRP. The repair analysis component 204 applies a difference model to the pre-repair digital twin and the post-repair digital twin to determine threshold KL divergence exists. A simulation is run with the allegedly replaced components substituted in the pre-repair digital twin and compared to the ideal digital twin. The post-repair sensor data analysis reveals enhanced emissions and worse engine performance relative to both the pre-repair digital twin and the ideal digital twin. In addition, the user input indicated persistent vehicle noise post-repair. The RFID associated with the replacement muffler also indicates that it was not among the viable spare parts, had a prior owner (despite being charged as new), and further that the real-time motion sensors indicate that the muffler is loose. The user is accordingly notified.

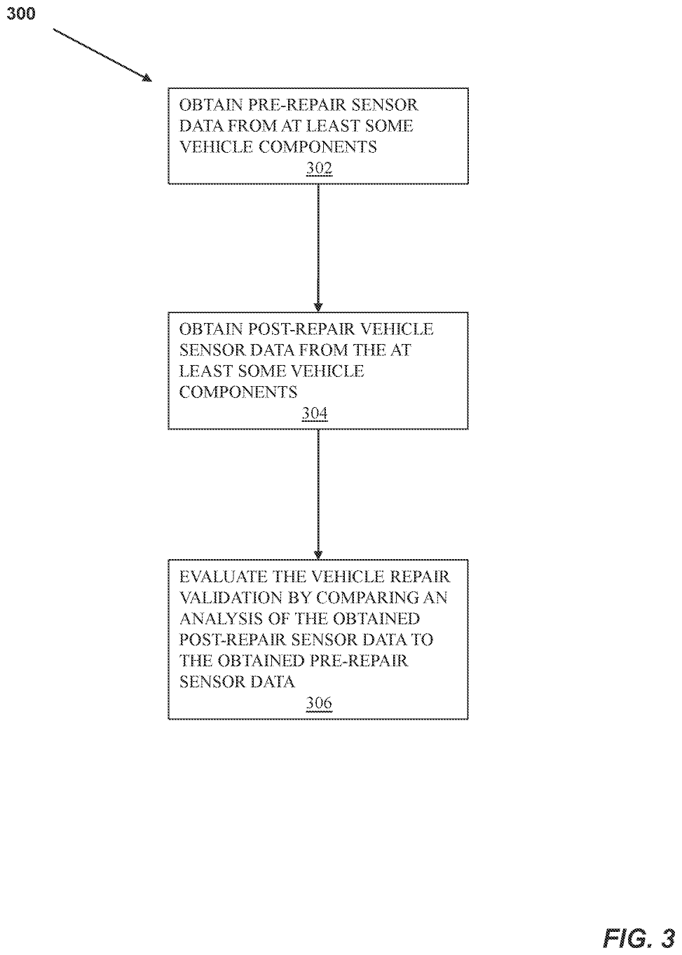

FIG. 3 illustrates a flowchart of sensor enabled vehicle repair validation 300, in accordance with an exemplary embodiment of the present inventive concept.

The obtainment component 202 can obtain pre-repair sensor data from at least some vehicle components (step 302).

The obtainment component 202 can obtain post-repair vehicle sensor data from the at least some vehicle components (step 304).

The repair analysis component 204 can evaluate the vehicle repair validation by comparing the obtained post-repair sensor data to the obtained pre-repair sensor data (step 306).

Based on the foregoing, a computer system, method, and computer program product have been disclosed. However, numerous modifications, additions, and substitutions can be made without deviating from the scope of the exemplary embodiments of the present inventive concept. Therefore, the exemplary embodiments of the present inventive concept have been disclosed by way of example and not by limitation.

What is claimed is:

1. A method of sensor enabled vehicle repair validation, the method comprising:
obtaining pre-repair sensor data from at least some pre-repair components of a vehicle;
obtaining post-repair sensor data from at least some post-repair components of the vehicle; and
performing the vehicle repair validation by comparing the obtained post-repair sensor data to the obtained pre-repair sensor data using a difference model.

2. The method of claim 1, further comprising:
generating a pre-repair digital twin of the vehicle using the obtained pre-repair sensor data; and
generating a post-repair digital twin of the vehicle using the obtained post-repair sensor data.

3. The method of claim 2, further comprising:
obtaining characteristic data corresponding to at least one of the at least some pre-repair components and the at least some post-repair components; and
extracting features from the obtained characteristic data, wherein the extracted features include performance data.

4. The method of claim 3, wherein the performing the vehicle repair validation by comparing the obtained post-repair sensor data to the obtained pre-repair sensor data using a difference model is based on the generated pre-repair digital twin and the generated post-repair digital twin.

5. The method of claim 4, wherein the pre-repair sensor data and the post-repair sensor data is obtained by IoT sensors.

6. The method of claim 5, wherein the IoT sensors include RFID sensors.

7. The method of claim 6, further comprising:
obtaining data related to represented vehicle repairs;
extracting features from the obtained data related to the represented vehicle repairs; and
comparing the extracted features from the obtained data related to the represented vehicle repairs with the extracted features corresponding to at least one of the at least some pre-repair components and the at least some post-repair components.

8. A computer program product for sensor enabled vehicle repair validation, the computer program product comprising:
one or more computer-readable storage media and program instructions stored on the one or more non-transitory computer-readable storage media capable of performing a method, the method comprising:
obtaining pre-repair sensor data from at least some pre-repair components of a vehicle;
obtaining post-repair sensor data from at least some post-repair components of the vehicle; and
performing the vehicle repair validation by comparing the obtained post-repair sensor data to the obtained pre-repair sensor data using a difference model.

9. The computer program product of claim 8, further comprising:
generating a pre-repair digital twin of the vehicle using the obtained pre-repair sensor data; and
generating a post-repair digital twin of the vehicle using the obtained post-repair sensor data.

10. The computer program product of claim 9, further comprising:
obtaining characteristic data corresponding to at least one of the at least some pre-repair components and the at least some post-repair components; and
extracting features from the obtained characteristic data, wherein the extracted features include performance data.

11. The computer program product of claim 10, wherein the performing the vehicle repair validation by comparing the obtained post-repair sensor data to the obtained pre-repair sensor data using a difference model is based on the generated pre-repair digital twin and the generated post-repair digital twin.

12. The computer program product of claim 11, wherein the pre-repair sensor data and the post-repair sensor data is obtained by IoT sensors.

13. The computer program product of claim 12, wherein the IoT sensors include RFID sensors.

14. The computer program product of claim 13, further comprising:
obtaining data related to represented vehicle repairs;
extracting features from the obtained data related to the represented vehicle repairs; and
comparing the extracted features from the obtained data related to the represented vehicle repairs with the extracted features corresponding to at least one of the at least some pre-repair components and the at least some post-repair components.

15. A computer system for sensor enabled vehicle repair validation, the computer system comprising:
one or more computer processors, one or more computer-readable storage media, and program instructions stored on the one or more of the computer-readable storage media for execution by at least one of the one or more processors capable of performing a method, the method comprising:
obtaining pre-repair sensor data from at least some pre-repair components of a vehicle;
obtaining post-repair sensor data from at least some post-repair components of the vehicle; and
performing the vehicle repair validation by comparing the obtained post-repair sensor data to the obtained pre-repair sensor data using a difference model.

16. The computer system of claim 15, further comprising:
generating a pre-repair digital twin of the vehicle using the obtained pre-repair sensor data; and
generating a post-repair digital twin of the vehicle using the obtained post-repair sensor data.

17. The computer system of claim 16, further comprising:
obtaining characteristic data corresponding to at least one of the at least some pre-repair components and the at least some post-repair components; and
extracting features from the obtained characteristic data, wherein the extracted features include performance data.

18. The computer system of claim 17, wherein the performing the vehicle repair validation by comparing the obtained post-repair sensor data to the obtained pre-repair sensor data using a difference model is based on the generated pre-repair digital twin and the generated post-repair digital twin.

19. The computer system of claim 18, wherein the pre-repair sensor data and the post-repair sensor data is obtained by IoT sensors.

20. The computer system of claim 19, wherein the IoT sensors include RFID sensors.
